(19) United States
(12) Patent Application Publication
(10) Pub. No.: US 2016/0139635 A1
(43) Pub. Date: May 19, 2016

(54) PROTECTIVE CASE FOR HYBRID COMPUTER

(71) Applicant: INFOCASE, INC., Cincinnati, OH (US)

(72) Inventors: Steven M. GIBSON, Maineville, OH (US); John R. MATTHEWS, Hamilton, OH (US)

(73) Assignee: INFOCASE, INC., Cincinnati, OH (US)

(21) Appl. No.: 14/542,852

(22) Filed: Nov. 17, 2014

(51) Int. Cl. G06F 1/16

(52) U.S. Cl. CPC G06F 1/1656; G06F 1/1654; G06F 1/1669; G06F 1/1616; G06F 1/1681

(57) ABSTRACT

A protective case for a hybrid computer having a removable screen and a separable keyboard. The case has a base panel, a lid and a flexible hinge attached to the rear of the base panel and separably connected to the rear of the lid, or attached to the rear of the lid and separably connected to the rear of the base panel, or separably connected to both the rear of the lid and the rear of the base panel. The protective case has separable means for attaching an interior surface of the lid to the removable screen of the computer and separable means for attaching an interior surface of the base panel to the keyboard. The lid can remain attached to the removable screen and the base panel can remain attached to the keyboard when the removable screen is separated from the keyboard.

### FIELD OF THE INVENTION

The invention relates to a protective case for a hybrid computer, specifically a hybrid computer having an independently functioning, removable screen and a separable keyboard. In particular, the invention relates to a protective case in which the computer may be kept during transport, storage and use, even when the removable screen of the computer is separated from the keyboard.

### BACKGROUND OF THE INVENTION

The industry has produced small portable or mobile computers, typically called notebook or hybrid computers in which the removable screen or tablet portion can be separated from the keyboard. The principal advantage of such computers is that they may be carried to and used wherever needed, and can be frequently separated when only the removable screen is being used. However, such separability and broad field of use may subject the computer, particularly the screen or tablet portion thereof, to physical damage. Most hybrid computers are not sufficiently durable to withstand physical damage that may be encountered during transport and use. Cases incorporated into the design of hybrid computers are typically made from plastic moldings. The complex shape needed to accommodate various internal components and connectors for external cables and the like dictate that the plastic be readily moldable and dimensionally stable over an extended period of time. Plastics meeting these requirements tend to be somewhat brittle. As a consequence, dropping an unprotected hybrid computer onto a hard surface may break its case and damage internal components. The removable screen is particularly susceptible to breakage.

Recognizing the vulnerability of hybrid computers to damage caused by dropping them onto hard surfaces, owners of such computers often place them in protective carrying cases. U.S. Pat. No. 6,109,434, Howard Jr., discloses an improved protective case for a portable computer that has a flexible hinge to accommodate opening and closing the computer and the case while the two remain attached to each other.

U.S. Pat. No. 7,414,833 discloses a case said to enable use of a laptop computer keyboard, display and ports located on a back edge of the computer while the computer remains in the case.

U.S. Pat. No. 8,599,542 discloses a reversible connection device to attach a cover to a tablet computer in two opposite configurations.

U.S. Pat. No. 8,817,457 discloses a reversible folio for a tablet computer having a shell with a cavity that removably receives the tablet computer.

While the above cases and covers may work for their intended purposes, there is a continuing need for an improved protective case for a hybrid computer having a separable keyboard because of the mass appeal of hybrid or tablet computers. The removable screen or tablet is extremely fragile when used as a freestanding computer.

### SUMMARY OF THE INVENTION

This invention relates to a protective case for a hybrid computer having a removable screen and a separable keyboard, said case comprising: a) a base panel having a front, a rear, a left side and a right side; b) a lid having a front, a rear, a left side and a right side; and c) a flexible hinge, attached to the rear of the base panel and separably connected to the rear of the lid, or attached to the rear of the lid and separably connected to the rear of the base panel, or separably connected to both the rear of the lid and the rear of the base panel, said flexible hinge having a left side, a right side, a front and a rear; wherein the base panel, the lid, and the flexible hinge each has an interior surface and exterior surface, and the protective case further comprises separable means for attaching the interior surface of the lid to the removable screen of the computer and separable means for attaching the interior surface of the base panel to the keyboard such that the lid can remain attached to the removable screen and the base panel can remain attached to the keyboard when the removable screen is separated from the keyboard.

The invention also relates to a combination of such a hybrid computer having a removable screen and a separable keyboard and protective case therefor in which the lid can remain attached to the removable screen and the base panel can remain attached to the keyboard when the removable screen is separated from the keyboard.

### BRIEF DESCRIPTION OF THE DRAWINGS

FIG. 1 is a perspective view of a hybrid computer attached inside a protective case of the invention.

FIG. 2 is a perspective view of the protective case of FIG. 1 without the computer.

FIG. 3 is a rear perspective view of the computer and protective case of FIG. 1 with the removable screen of the computer separated from the keyboard, the lid of the case attached to the removable screen, and the base panel of the case attached to the keyboard.

FIG. 4 is a cross section through the center of the protective case and hybrid computer of FIG. 1.

FIG. 5 is an enlarged view of a portion of FIG. 4.

FIG. 6 is a perspective view of the protective case and computer of FIG. 1 in a closed configuration.

### DETAILED DESCRIPTION OF THE INVENTION

The protective case of the invention can remain around a hybrid computer even when the removable screen (or tablet portion) of the computer is separated from the keyboard. Thus, the case protects the computer from damage that might occur during transportation, storage and use when the removable screen is connected to, or separated from, the keyboard. The case is designed to provide such protection without interfering with normal operation of the computer.

The protective case is configured such that it surrounds a hybrid computer in a traditional clamshell form, and is separably attached to the computer. The removable screen of the computer is separably attached to the interior surface of the lid of the case, and the keyboard is separably attached to the interior surface of the base panel of the case. The case includes a flexible hinge such that the lid of the case can be raised or lowered without interfering with the movement of the removable screen relative to its keyboard and base. Moreover, the removable screen can be separated from the keyboard while the lid of the case remains attached to the removable screen and the base panel of the case remains attached to the keyboard. Thus, the modular case provides protection to the computer, both when the removable screen and keyboard are attached and when they are separated. The base panel and lid of the case can be quickly and easily separated to provide a near seamless transition between using the computer in assembled and separated modes.

The protective case may be comprised of structural components having combinations of a rigid layer, a resilient layer, and one or more fabric layers. The rigid layer maintains the flat configuration, preventing collapse of the case if dropped onto a hard surface, or if a heavy object is placed on top of the case. The resilient layer absorbs energy if the computer inside the case is dropped onto a hard surface. The fabric layer(s) provide convenient means of construction, by sewing, and a durable outside surface material similar to that widely used in suitcases.

The flexible hinge of the protective case should allow easy access to cable connectors on the rear of the computer, whether the computer is in an open or closed configuration. The flexible hinge may contain a layer of resilient material on its interior surface to offer additional protection to the back side of the computer, should it be dropped. Where the protective case includes two or more flexible hinges, a gap between them may increase ventilation of the computer.

Other advantages of the present invention will be understood and appreciated by reference to the following detailed description, and the appended claims and drawings. It should be noted that terminology referring to or suggesting orientation of either a hybrid computer or the protective case describes orientation with respect to the position of a user, who has positioned the computer on his/her lap or on a work area in front of himself/herself.

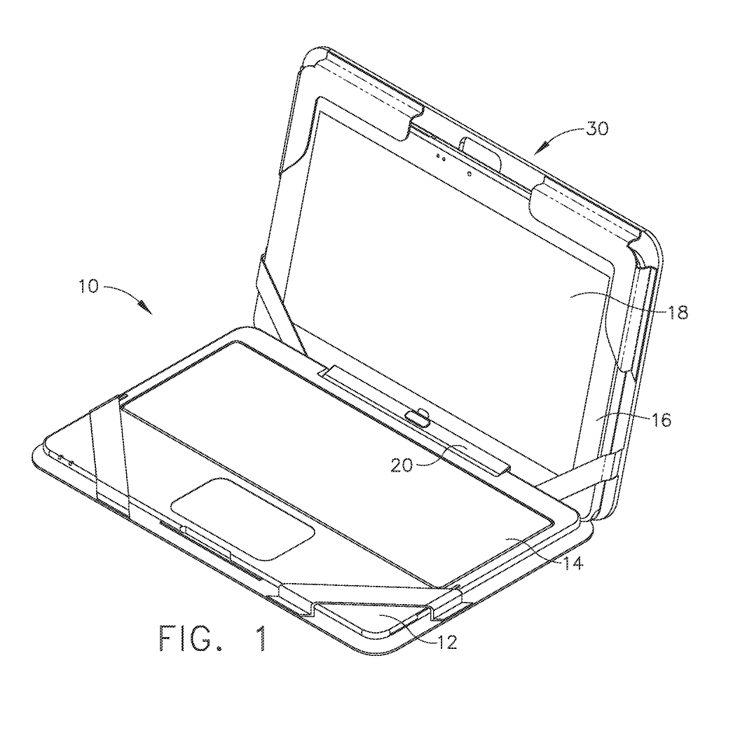

A typical tablet hybrid computer 10 is shown in FIG. 1. In one example, when closed, it is about 11.5 inches wide by 7.5 inches top-to-bottom by 0.5 inches thick. The size of the protective case of the invention can be adjusted to accommodate larger or smaller hybrid computers. The computer 10 is comprised of two major components, a base 12 which houses a keyboard 14 and may house other components, cable connectors and disk drives, and a removable screen 16, which houses the display screen 18 and may house other components and connectors of the computer. The base and removable screen of the computer are connected by a hinge 20.

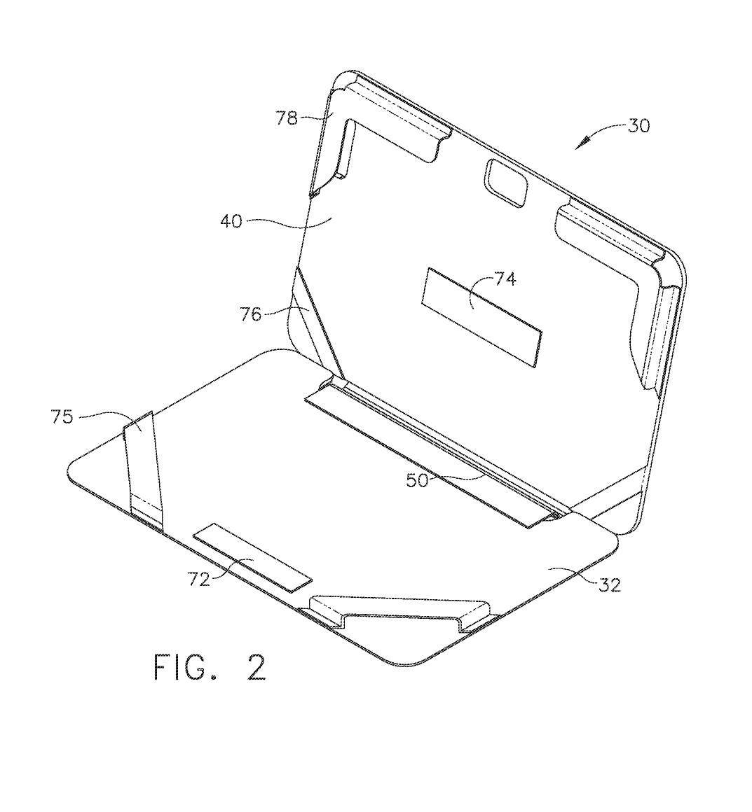

The hybrid computer 10 can be effectively operated while it is inside the protective case 30, as shown in FIG. 1. The protective case 30 is shown without the computer in FIG. 2. The principal components of the protective case are a base panel 32, a lid 40, and a flexible hinge 50. The base panel 32, the lid 40, and the flexible hinge 50 each has a front, a rear, a left side, a right side, an interior surface and an exterior surface. The flexible hinge is typically attached to the rear of the base panel, for example, by being sewn thereto, and separably connected to the rear of the lid. Various materials may be used to separably connect the flexible hinge to the lid, including magnets, hook-and-loop fasteners, snaps and zippers. Alternatively, the flexible hinge may be attached to the rear of the lid and separably connected to the rear of the base panel, or the flexible hinge may be separably connected to both the rear of the lid and the rear of the base panel.

The protective case further comprises separable means for attaching the interior surface of the lid to the removable screen of the computer and separable means for attaching the interior surface of the base panel to the keyboard. The separable means for attaching may be one or more strips of hook-and-loop fastener material sewn or otherwise affixed to the interior surface of the base panel 32 and/or lid 40. One or more strips of mating hook-and-loop material may be affixed, e.g., adhesively attached, to the external surface of the base 12 and/or removable screen 16 of the computer. In the protective case 30 shown in FIG. 2, the separable means for attaching the case to the computer include hook-and-loop fastener strips 72 and 74 sewn to the interior surface of base panel 32 and lid 40, respectively, which mate with corresponding hook-and-loop fastener strips on the external surface of the base 12 and removable screen 16 of the computer, respectively. The separable means for attaching the case to the computer also include elastic straps, and/or thermopolyurethane straps, 75 sewn or otherwise affixed to the interior surface of the front corners of base panel 32. The separable means for attaching also include elastic and/or thermopolyurethane straps 76 sewn or otherwise affixed to the interior surface of the rear corners of lid 40. Straps 76 optionally, are slid off the corners of the removable screen of the computer when it is attached to the keyboard. The separable means for attaching the case to the computer also include side gussets 78, for example, made of fabric or plastic material, sewn or otherwise affixed to the interior surface of the front corners of lid 40. Combinations of such separable means for attaching the case to the computer, and other separable means, may be used. Such separable means help retain attachment of the lid to the removable screen, and the base panel to the keyboard, when the removable screen is separated from the keyboard.

To further resist damage to the computer if it is dropped onto a hard surface or a heavy load placed on top of the computer, the lid and the base panel of the protective case may be comprised of a rigid layer and a resilient layer. For the base panel, a rigid layer may be nearer to the interior of the protective case than a resilient layer. For other components, a resilient layer may be nearer to the interior. The base panel may be so designed because some hybrid computers have ventilation ports through the bottom surfaces of their bases. A resilient layer adjacent to the base of such a computer might obstruct the ventilation ports. Otherwise, having a resilient layer adjacent the computer offers cushioning against shock should the computer be dropped. A flexible layer of polymeric material, such as polystyrene, for example, about 0.01 inches thick, may be inserted between rigid and resilient layers.

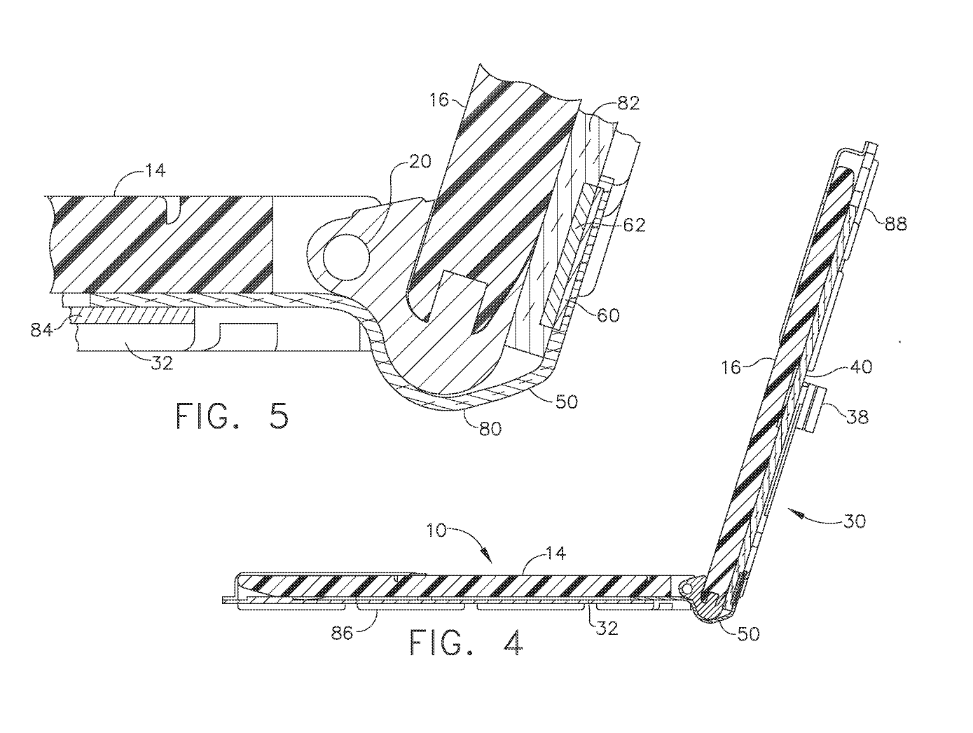

In order to allow the protective case to remain attached to the computer during use, it is necessary to provide flexibility in the hinge component of the protective case. The need for such flexibility arises because the axis of computer hinge 20 connecting the removable screen 16 of the computer to the base 12 cannot conveniently be made to coincide with any point on the rear of the protective case 30. As the removable screen 16 and base 12 of the computer and the lid 40 and base panel 32 of the case are typically substantially rigid elements, opening the computer with the case attached thereto requires that the flexible hinge 50 not only bend at some point near the axis of hinge 20, but also become shorter, as measured in its front-to-back length. The function of flexible hinge 50 is illustrated in FIGS. 4 and 5. The flexible hinge comprises fabric layer 80 used in the construction of the case. Thus, the hinge is fully capable of both bending and wrinkling, to provide the necessary flexibility. The front-to-back length of the flexible hinge is typically at least ½ inch to accommodate the motion of the removable screen or lid of the computer. However, the length of the flexible hinge should be minimized in order to minimize the depth of the protective case that does not include rigid and resilient layers. The length of the flexible hinge also depends on the design of the hybrid computer, and how it is situated within the protective case. The length of the flexible hinge may also be expressed as being equal to, or slightly greater than, the distance between the top front edge of the lid of the computer to the top rear edge of the base of the computer, when the computer is closed, less the distance between the same points when the computer is opened to a normal operating position.

The flexible hinge is typically attached to the rear of the base panel and separably connected to the rear of the lid. In one embodiment, the flexible hinge is separably magnetically connected to the rear of the lid. In the protective case shown in FIGS. 4 and 5, flexible hinge 50 comprises one or more magnetic disks or strips 60 sewn into fabric 80 along the length of the rear of the flexible hinge. One or more corresponding magnetic strips 62 are sewn into fabric 82 at the rear of lid 40. The fabric 80 along the front of flexible hinge 50 is sewn into the fabric 84 along the length of the rear of base panel 32. The flexible hinge 50 can be quickly and easily magnetically connected to the rear of the lid and separated therefrom. The flexible hinge may be separably connected to the rear of the lid using other means and materials, for example, using hook-and-loop fastener materials, snap attachment, or a zipper. Alternatively, the flexible hinge may be attached to the rear of the lid and separably connected to the rear of the base panel, or the flexible hinge may be separably connected to both the rear of the lid and the rear of the base panel, using the above or other means and materials.

The protective case may be provided with gussets, such as disclosed in U.S. Pat. No. 6,109,434, incorporated herein by reference, attached to the front, left side and right side of the lid and/or base panel. The gussets may form a protective hood over the removable screen of the computer, and the fragile display screen incorporated therein, or over the base and/or keyboard of the computer. Such a hood may provide increased protection for the computer when it is open for use or closed for transport or storage.

The flexible hinge 50 may be shorter in width, from its left side to its right side, than the base panel 32 and lid 40 of the protective case to provide access to the rear of the computer where cable connections may be located and enhanced ventilation of the computer. Gaps in the flexible hinge or between flexible hinges may be desired to provide a pathway for ventilation and also for cables used with the computer. The thickness of a resilient layer in the flexible hinge may be greater than that of resilient layers in other components of the case to provide additional protection for the computer, should it be dropped onto a hard surface.

In one embodiment of the invention, the base panel 32, lid 40 and/or flexible hinge 50 are fabricated with fabric layers on interior and/or exterior surfaces thereof, such as fabric layers 80, 82 and 84 shown in FIGS. 4 and 5, and with rigid and resilient layers disposed thereon or between, such as layers 86 and 88, respectively.

The materials employed in manufacturing the protective case can be selected for light weight, durability and resistance to moisture. The material for rigid layers may be rigid polypropylene sheeting. Other materials, such as corrugated polymeric material, compressed wood fiber or metal sheet, may be employed. The material for resilient layers may be a polymeric foam material, such as polyethylene or polyurethane foam, e.g., a fairly dense grade of polyethylene foam. The fabric layer on the exterior of the protective case may be a heavy-duty fabric, typically made of nylon, polyester or polyvinyl chloride, similar to that used in manufacturing suitcases. It may be bonded to a thin polymeric foam backing, which improves durability and water tightness. In one example, the case has a ballistic nylon exterior to provide a high degree of protection and a rugged appearance. A vinyl exterior fabric may be used for a more fashionable appearance or to allow the case to be wiped clean more easily. A lightweight, tightly woven nylon fabric is preferred for a fabric layer on the interior of the protective case. In another embodiment of the invention, natural leather, synthetic leather or a sheet polymeric material such as polyvinyl chloride may be substituted for either or both of the fabric layers.

While the present invention has been described as constructed from fabric, together with rigid and/or resilient layers, a protective case could be constructed from a rigid shell, with resilient materials incorporated inside the shell. It would also be possible to fabricate such a protective case from molded polyethylene foam with cloth coverings bonded to both sides. Such a case could be designed specifically for a particular model of hybrid computer to duplicate the action of the hinge during opening and closing.

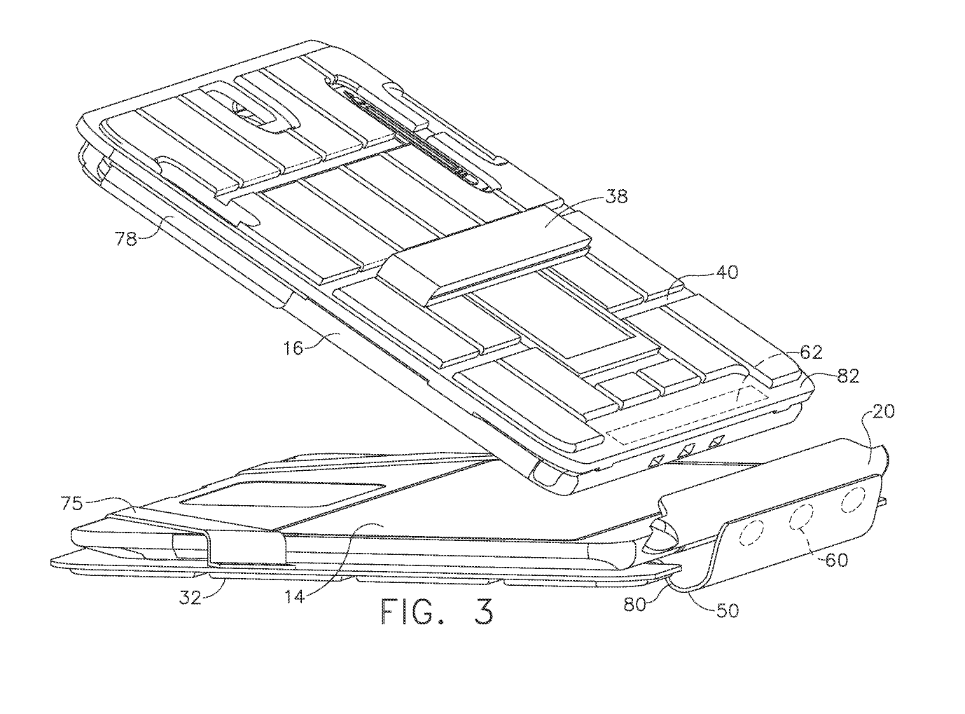

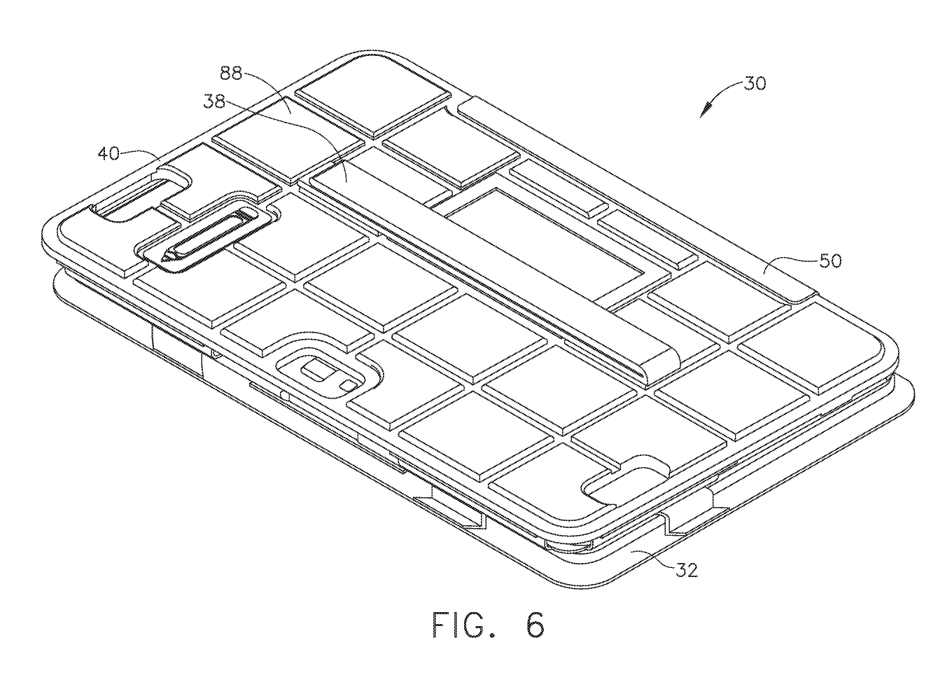

Means for carrying the protective case, and a hybrid computer therein, may include a handle, such as handle or hand strap 38 shown in FIGS. 3 and 6, attached to lid 40 of case 30. A shoulder strap, not shown, may be attached to the left and right sides of the case. A harness, optionally attached to the left and right sides of the case, and worn around the neck and/or shoulders of the user, would support the computer and facilitate operation in the standing position. An elastic strap, attached to the exterior surface of the base panel at the front and back may be provided to secure the computer and protective case to one wrist of the user, while he/she operates the computer with the other hand.

A separable connecting means, for example a strap or a zipper, may be provided on the protective case to close it for storage or transport. The configuration of such means can be developed to provide secure closure without interfering with opening of the computer within the case. Attaching the separable connecting means to the base panel and lid of the case, directly or indirectly through other components, should allow easy access to cable connectors or disk drives that may be incorporated into the front or sides of the computer. Further, this configuration may provide ventilation for the computer. A carrying means, such as a handle, hand strap or shoulder strap, may be attached to the case.

The protective case of the invention may include, in various embodiments: (1) means for attaching the case to a hybrid computer, so that it can remain there while the computer is being used, stored or transported; (2) an improved flexible hinge that can accommodate the relative motion between the case and the computer while the computer is being opened or closed, and when the removable screen is separated from the keyboard; (3) a base panel that is larger than the computer, to provide protection when the case is closed and access to the sides and front of the computer when the case is open, and to enhance ventilation of the computer; (4) components of the protective case that combine rigidity, shock absorbing and resistance to damage by abrasion or cutting; (5) means for conveniently carrying the computer in its case; (6) means for supporting the computer on the operator's arm during operation; and (7) easy opening, closing and separation of the lid from the base panel of the case to facilitate setting up, closing and separation of the computer and case attached thereto.

In another embodiment, the invention relates to a combination a hybrid computer and a protective case therefor, comprising:

a hybrid computer comprising: a keyboard having a bottom, left and right sides, front and rear portions and a top surface; a removable screen having a top, left and right sides, front and rear portions and a bottom surface; and a hinge for pivotably securing the rear portion of the removable screen to the rear portion of the keyboard; wherein the computer may be in a closed condition in which access to the keyboard and removable screen is precluded by the close proximity of the keyboard to the screen; and the computer may be in an open condition which provides access to the keyboard and removable screen; and
a protective case comprising: a) a base panel having a front, a rear, a left side and a right side; b) a lid having a front, a rear, a left side and a right side; and c) a flexible hinge, attached to the rear of the base panel and separably connected to the rear of the lid, or attached to the rear of the lid and separably connected to the rear of the base panel, or separably connected to both the rear of the lid and the rear of the base panel, said flexible hinge having a left side, a right side, a front and a rear; wherein the base panel, the lid, and the flexible hinge each has an interior surface and exterior surface, and the protective case further comprises separable means for attaching the interior surface of the lid to the removable screen of the computer and separable means for attaching the interior surface of the base panel to the keyboard such that the lid can remain attached to the removable screen and the base panel can remain attached to the keyboard when the removable screen is separated from the keyboard.

While the present invention has been described with reference to certain embodiments, it will be appreciated that the invention is not limited thereby. In particular, the concepts of the invention are applicable to protective cases for notebook computers, sub-notebook computers, palmtop computers, or laptop computers. Those skilled in the art will recognize that variations and modifications in the design and construction of a protective case for a hybrid computer, as described herein, lie within the spirit and scope thereof, and all such variations and modifications fall within the scope of the invention defined by the following claims.

We claim:

1. A protective case for a hybrid computer having a removable screen and a separable keyboard, said case comprising:
a) a base panel having a front, a rear, a left side and a right side;
b) a lid having a front, a rear, a left side and a right side; and
c) a flexible hinge, attached to the rear of the base panel and separably connected to the rear of the lid, or attached to the rear of the lid and separably connected to the rear of the base panel, or separably connected to both the rear of the lid and the rear of the base panel, said flexible hinge having a left side, a right side, a front and a rear;
wherein the base panel, the lid, and the flexible hinge each has an interior surface and exterior surface, and the protective case further comprises separable means for attaching the interior surface of the lid to the removable screen of the computer and separable means for attaching the interior surface of the base panel to the keyboard such that the lid can remain attached to the removable screen and the base panel can remain attached to the keyboard when the removable screen is separated from the keyboard.

2. The protective case of claim 1 wherein the base panel and the lid each comprises a fabric layer and a resilient layer.

3. The protective case of claim 1 wherein the flexible hinge comprises a fabric layer.

4. The protective case of claim 1 wherein the flexible hinge is attached to the rear of the base panel and separably connected to the rear of the lid.

5. The protective case of claim 1 wherein the flexible hinge is separably magnetically connected to the rear of the lid.

6. The protective case of claim 1 wherein the separable means for attaching the interior surface of the lid to the removable screen, and the separable means for attaching the interior surface of the base panel to the keyboard, comprise hook-and-loop fastening material.

7. The protective case of claim 1 wherein the separable means for attaching the interior surface of the lid to the removable screen, and the separable means for attaching the interior surface of the base panel to the keyboard, comprise elastic straps and/or thermopolyurethane straps.

8. The protective case of claim 7 wherein the separable means for attaching the interior surface of the lid to the removable screen, and the separable means for attaching the interior surface of the base panel to the keyboard, further comprise hook-and-loop fastening material.

9. The protective case of claim 1 wherein the exterior surface of the lid comprises carrying means.

10. A protective case for a hybrid computer having a removable screen and a separable keyboard, said case comprising:
a) a base panel having a front, a rear, a left side and a right side;
b) a lid having a front, a rear, a left side and a right side; and
c) a flexible hinge, attached to the rear of the base panel and separably connected to the rear of the lid, said flexible hinge having a left side, a right side, a front and a rear;
wherein the base panel, the lid, and the flexible hinge each has an interior surface and exterior surface, and the protective case further comprises separable means for attaching the interior surface of the lid to the removable screen of the computer and separable means for attaching the interior surface of the base panel to the keyboard such that the lid can remain attached to the removable screen and the base panel can remain attached to the keyboard when the removable screen is separated from the keyboard.

11. The protective case of claim 10 wherein the base panel and the lid each comprises a fabric layer and a resilient layer.

12. The protective case of claim 10 wherein the flexible hinge comprises a fabric layer.

13. The protective case of claim 10 wherein the flexible hinge is separably magnetically connected to the rear of the lid.

14. The protective case of claim 10 wherein the separable means for attaching the interior surface of the lid to the removable screen, and the separable means for attaching the interior surface of the base panel to the keyboard, comprise hook-and-loop fastening material.

15. The protective case of claim 10 wherein the separable means for attaching the interior surface of the lid to the removable screen, and the separable means for attaching the interior surface of the base panel to the keyboard, comprise elastic straps and/or thermopolyurethane straps.

16. The protective case of claim 15 wherein the separable means for attaching the interior surface of the lid to the removable screen, and the separable means for attaching the interior surface of the base panel to the keyboard, further comprise hook-and-loop fastening material.

17. The protective case of claim 16 wherein the flexible hinge is separably magnetically connected to the rear of the lid.

18. A combination of a hybrid computer and a protective case therefor, comprising:
a hybrid computer comprising:
a keyboard having a bottom, left and right sides, front and rear portions and a top surface;
a removable screen having a top, left and right sides, front and rear portions and a bottom surface; and
a hinge for pivotably securing the rear portion of the removable screen to the rear portion of the keyboard;
wherein the computer may be in a closed condition in which access to the keyboard and removable screen is precluded by the close proximity of the keyboard to the screen; and
the computer may be in an open condition which provides access to the keyboard and removable screen; and
a protective case comprising:
a) a base panel having a front, a rear, a left side and a right side;
b) a lid having a front, a rear, a left side and a right side; and
c) a flexible hinge, attached to the rear of the base panel and separably connected to the rear of the lid, or attached to the rear of the lid and separably connected to the rear of the base panel, or separably connected to both the rear of the lid and the rear of the base panel, said flexible hinge having a left side, a right side, a front and a rear;
wherein the base panel, the lid, and the flexible hinge each has an interior surface and exterior surface, and the protective case further comprises separable means for attaching the interior surface of the lid to the removable screen of the computer and separable means for attaching the interior surface of the base panel to the keyboard such that the lid can remain attached to the removable screen and the base panel can remain attached to the keyboard when the removable screen is separated from the keyboard.

19. The combination of the hybrid computer and the protective case of claim 18 wherein the flexible hinge of the protective case is attached to the rear of the base panel and separably connected to the rear of the lid.

20. The combination of the hybrid computer and the protective case of claim 19 wherein the flexible hinge of the protective case is separably magnetically connected to the rear of the lid.
